(19) United States
(12) Patent Application Publication
(10) Pub. No.: US 2008/0230415 A1
(43) Pub. Date: Sep. 25, 2008

(54) Dental base and tray

(76) Inventor: Phillip Mark, Orlando, FL (US)

Correspondence Address: MCDERMOTT, WILL & EMERY LLP, 227 WEST MONROE STREET, SUITE 4400, CHICAGO, IL, 60606-5096, US

(21) Appl. No.: 11/725,908

(22) Filed: Mar. 19, 2007

(51) Int. Cl. A61C 19/02

(52) U.S. Cl. 206/369

(57) ABSTRACT

A dental base and disposable tray includes a base with a plurality of disposable tip holders and a disposable tray mating portion. The disposable tray includes a work surface with mixing wells, an instrument holder and disposable tip holders. The disposable tray also includes a base mating portion. When the base and disposable tray are mated together, the disposable tray protects the base from being contaminated by materials or instruments held on or in the work surface.

### TECHNICAL FIELD

The disclosed embodiments relate generally to a dental base and tray. More specifically, the present subject matter relates to a dental base and a replaceable tray for holding micro-applicators, disposable tips and other materials.

### BACKGROUND

Trays are used by dentists for holding and mixing materials used in dental procedures. Dental trays typically include a plurality of mixing wells which may be used to hold or mix sealants, bonding agents, etchants, hemostatic solutions, cavity liners, disclosing solutions, etc. Dental trays must maintain separation between the materials and mixtures as contamination can be detrimental to the procedures.

Micro-applicators are used in dental procedures to apply the materials held in the trays. Micro-applicators are pen-like instruments with application tips. The tip portion is often a bristled tip optimized for the application of a fluid or paste. The application tips may be removable and disposable. Dental trays designed to hold micro-applicators and/or tips must prevent contamination and cross-contamination of the instruments and the tray itself.

Non-disposable trays must be autoclaved between uses in order to maintain sanitary conditions for dental procedures. Existing disposable trays are not well adapted to hold and maintain the cleanliness of the instruments and materials. For example, existing trays do not combine mixing wells, pen holders and tip holders in a disposable form that prevent contamination and cross-contamination or the materials and instruments.

Therefore, a need exists for a dental base and tray that addresses and overcomes the limitations of the prior art.

### SUMMARY

The above and other needs are met by the disclosed embodiments which provide a dental base and a replaceable tray for holding micro-applicators, disposable tips and other materials. A dental base and disposable tray includes a base with a plurality of disposable tip holders and a disposable tray mating portion. The disposable tray includes a work surface with mixing wells, an instrument holder and disposable tip holders. The disposable tray also includes a base mating portion. When the base and disposable tray are mated together, the disposable tray protects the base from being contaminated by materials or instruments held on or in the work surface.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF DRAWINGS

The drawing figures depict one or more implementations in accord with the present concepts, by way of example only, not by way of limitations. In the figures, like reference numerals refer to the same or similar elements.

FIG. 1 is a perspective view of a disposable tray.

FIG. 2 is a perspective view of a base for mating with the disposable tray shown in FIG. 1.

FIG. 3 is a side view cross-sectional side view of the interface between the base shown in FIG. 2 and the disposable tray shown in FIG. 1.

### DETAILED DESCRIPTION OF PREFERRED EMBODIMENTS

It is contemplated that the subject matter described herein may be embodied in many forms. Accordingly, the embodiments described in detail below are the presently preferred embodiments, and are not to be considered limitations.

The disclosed embodiments address problems related to dental bases and trays. The disclosed embodiments solve these problems, at least in part, by providing a dental base and a replaceable tray for holding micro-applicators, disposable tips and other materials. For example, a dental base and disposable tray includes a base with a plurality of disposable tip holders and a disposable tray mating portion. The disposable tray includes a work surface with mixing wells, an instrument holder and disposable tip holders. The disposable tray also includes a base mating portion. When the base and disposable tray are mated together, the disposable tray protects the base from being contaminated by materials or instruments held on or in the work surface.

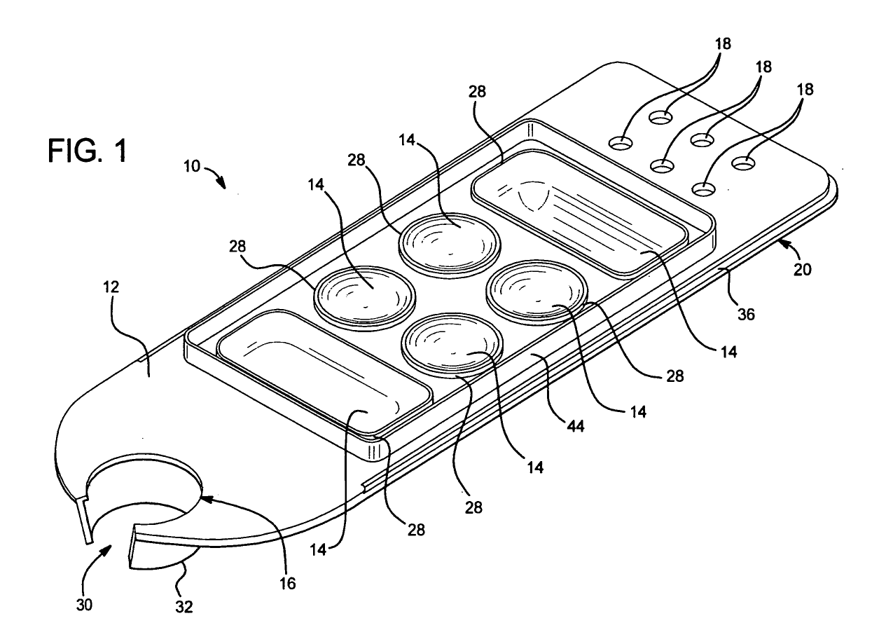

FIG. 1 illustrates a disposable tray 10. As shown, the disposable tray 10 includes a work surface 12, which in FIG. 1 is the top surface of the disposable tray 10. The work surface 12 includes a plurality of mixing wells 14, an instrument holder 16 and a plurality of disposable tip holders 18. As further shown in FIG. 1, the disposable tray 10 includes a base mating portion 20. The base mating portion 18 shown in FIG. 1 is flange 36 located along three sides of the disposable tray 10 for mating with a base 22, as described further below.

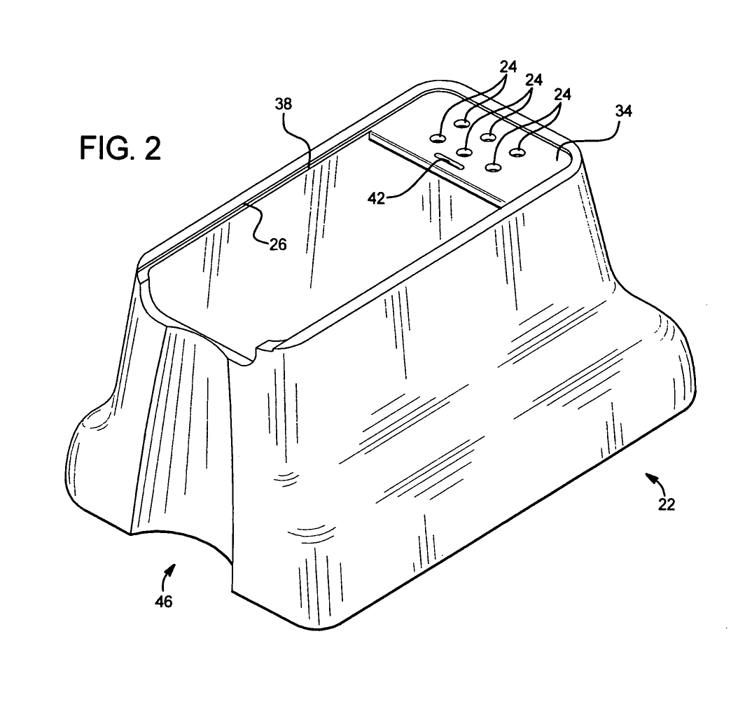

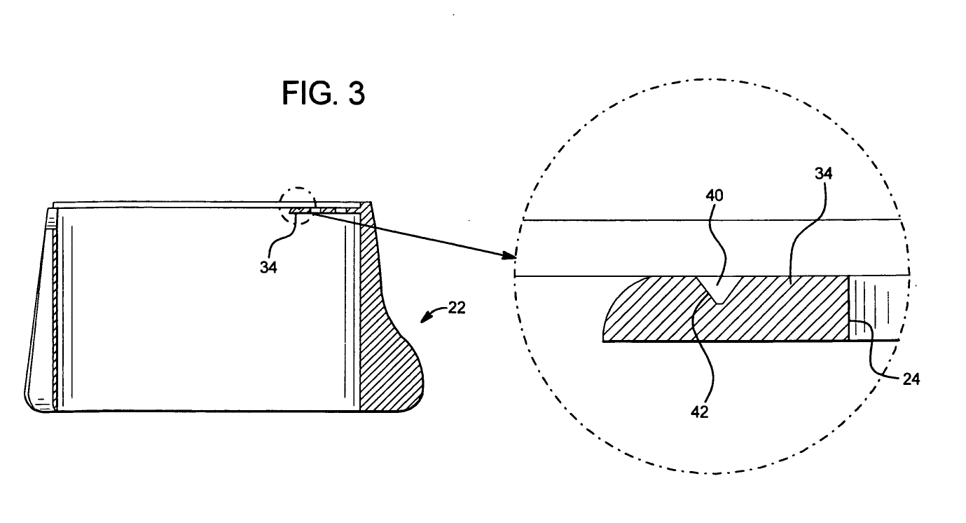

FIGS. 2 and 3 illustrate the base 22. The base 22 shown in FIGS. 2 and 3 includes a plurality of disposable tip holders 24 and a disposable tray mating portion 26. The disposable tray mating portion 26 shown in FIGS. 2 and 3 is a receiving slot 38 for receiving the flange 36 of the disposable tray 10 shown in FIG. 1.

It is understood that the embodiments of the disposable tray 10 and base 22 shown in FIGS. 1-3 are merely one contemplated embodiment of each that meets the needs expressed above by implementing the solutions provided herein. Although these examples are the presently preferred embodiments for implementing the solutions provided herein, it is understood that each of the disposable tray 10 and the base 22 may be embodied in any number of other configurations. For example, any number and configuration of mixing wells 14, instrument holders 16 and plurality of disposable tip holders 18 may be implemented in a disposable tray 10. Further the base mating portion 20 and the disposable tray mating portion 26 may be embodied in other forms, such as, for example, snap fit, latched engagement, etc. Additional embodiments will be described and/or become apparent to one skilled in the art in reading the descriptions herein.

In the embodiment of the disposable tray 10 shown in FIG. 1, the work surface 12 includes six mixing wells 14. As shown in FIG. 1, there are four circular mixing wells 14 and two larger, generally rectangular, mixing wells 14. The various sizes and shapes of mixing well 14 may vary to accommodate different material requirements for different dental procedures or for any other reason. Each of the mixing wells 14 is surrounded by a raised material barrier 28 that prevents materials in the mixing wells 14 from cross-contaminating each other if the disposable tray 10 is disturbed. Other forms of material barriers 28 may be employed, for example, depressed material barriers 28 may be substituted or a combination of raised and depressed material barriers 28 may be used.

Further, one or more covers or lids may be provided to seal the mixing wells 14 to prevent contamination and cross-contamination of the materials held therein. Therefore, a cover or lid engaging portion 44 is provided as shown in FIG. 1. The cover or lid engaging portion 44 shown is a raised wall surrounding the mixing wells 14, however, any cover or lid engaging portion 44 may be used to facilitate covering one or more of the mixing wells 14.

Often, dental procedures involve the use of light cured materials. These materials are often placed in and held by the disposable tray 10 for extended periods of time. Accordingly, the disposable tray 10 and any associated covers and lids may be formed from light blocking materials to prevent activation of materials held therein. However, in certain embodiments only the cover or lid may be formed of light blocking material and in still other embodiments, neither the disposable tray 10 or covers or lids will be formed from light blocking material.

In the example shown in FIG. 1, the circular mixing wells 14 are approximately 0.400 inches in diameter and approximately 0.220 inches deep and the generally rectangular mixing wells 14 are approximately 0.960 inches long, 0.400 inches wide and 0.225 inches deep. The generally vertical walls of the generally rectangular mixing wells 14 may actually be angled at approximately eighteen degrees and the corners of the generally rectangular mixing wells 14 may have a radius of 0.132 inches. However, as stated above, any other dimensions may be used as needed.

As further shown in the example shown in FIG. 1, the work surface 12 includes one instrument holder 16. The instrument holder 16 shown is a pen holder, for example for holding a micro-applicator pen. In the embodiment shown in FIG. 1, the instrument holder 16 is a semi-circular cutout 30 within the work surface 12 that includes a semi-cylindrical sleeve 32 that extends beneath the cutout 30. The cutout 30 and sleeve 32 help locate the instrument within the instrument holder 16 and prevent the instrument from making contact with the base 22, as described further below.

In the embodiment shown in FIG. 1, the cutout 30 has a diameter of approximately 0.500 inches and the sleeve 32 extends approximately 0.225 inches beneath the work surface 12. However, as stated above, any other dimensions may be used as needed to hold various shaped and sized instruments. Further, other examples may include a plurality of instrument holders 16.

The plurality of disposable tip holders 18 shown in the example provided in FIG. 1, include positions for six disposable tips. The number and configurations of the disposable tip holders 18 may vary to meet the needs of the particular application. The disposable tip holders 18 shown in FIG. 1 are approximately 0.100 inches in diameter and approximately 0.250 inches center to center to allow appropriate spacing between the disposable tip holders 18 for an instrument to engage the disposable tips held therein. Although other designs may be implemented, the disposable tip holders 18 shown in FIG. 1 are circular holes that pass through the thickness of the disposable tray 10 and correspond to the disposable tip holders 24 located in the base 22, as described further below.

The example of the base 22 shown in FIGS. 2 and 3 includes six disposable tip holders 24 that correspond to the disposable tip holders 18 in the disposable tray 10 shown in FIG. 1. Just as with the disposable tray 10 described above, the number, size, shape and configuration of disposable tip holders 24 in the base 22 may be varied to meet the needs of the dental care provider.

The disposable tip holders 24 shown in FIGS. 2 and 3 are located within a tip holding platform 34. As shown, the disposable tip holders 24 are circular holes approximately 0.100 inches in diameter and approximately 0.250 inches center to center that extend through the relatively thin tip holding platform 34. In the example shown in FIGS. 2 and 3, the tip holding platform 34 is approximately 0.050 inches thick. Because the disposable tips will pass through the tip holding platform 34, the base 22 will not damage the sensitive application heads of the disposable tips. Moreover while stored within the hollow base 22, the disposable tips are protected from contamination.

FIG. 3 illustrates the cooperation of the base mating portion 20 and the disposable tray mating portion 26 to hold the disposable tray 10 onto the base 22. As shown in FIG. 3, the flange 36 of the disposable tray 10 slides into the receiving slot 38 to hold the disposable tray 10 to the base 22. Because the flange 36 and receiving slots 38 are located along three sides of the disposable tray 10 and base 22 the disposable tray 10 is removably held in place within the base 22.

As further shown in FIG. 3, the disposable tray 10 includes a locating ridge 40 that cooperates with a locating notch 42 in the base 22 to removably secure the disposable tray 10 within the base 22. In the example provided, the locating ridge 40 is approximately 0.300 inches long, 0.017 inches high with an approximately 0.005 inch radius at the peak and sides that angle at approximately 75 degrees. The locating notch 42 has corresponding dimensions to facilitate secure engagement between the locating ridge 40 and locating notch 42.

As shown, when the disposable tray 10 is properly inserted into the base 22, the locating ridge 40 is located within the locating notch 42. Therefore, to remove the disposable tray 10 from the base 22, sufficient force must be applied to the disposable tray 10 to dislodge the locating ridge 40 from the locating notch 42. This interface provides feedback to a user that the disposable tray 10 is properly seated within the base 22 and further secures the disposable tray I 0 in the base 22. It is contemplated that other locating mechanisms or none at all, may be used in other embodiments of the disposable tray 10 and base 22.

In the example provided in FIGS. 2 and 3, the base 22 includes an instrument cutaway 46 to allow adequate spacing between the base 22 and any instrument held within the disposable tray 10 to prevent the instrument from contacting and contaminating the base 22. The base 22 may be otherwise configured with various numbers, sizes and shapes of instrument cutaways 46, but it is advantageous to maintain adequate clearance between the base 22 and any instrument held thereto to prevent unnecessary contamination, requiring additional autoclaving, of the base 22.

The base 22 shown in FIGS. 2 and 3 is a stable platform for supporting the disposable tray 10 and the instruments and materials held thereon. Although numerous shapes and sizes are appropriate for meeting the needs of a stable base 22, the presently preferred embodiment is shown in FIGS. 2 and 3.

The disposable tray 10 described herein may be made of a polymeric material or any other material that is useful for disposable medical products. The base 22 may be formed from metal, such as stainless steel or aluminum, and may be further covered in a polymeric material. However, the materials described herein are just a few examples of the many materials that may be appropriate for use with the disposable tray 10 and base 22 provided herein.

The use of a disposable tray 10 allows a single base 22 to be used with multiple configurations of disposable trays 22 and further allows for the base 22 to be used for multiple procedures without a need for autoclaving. Thus, between procedures, a user need only replace the disposable tray 10 and the contents thereon making for more efficient changeovers between procedures.

It should be noted that various changes and modifications to the presently preferred embodiments described herein will be apparent to those skilled in the art. Such changes and modifications may be made without departing from the spirit and scope of the present invention and without diminishing its attendant advantages.

I claim:

1. A dental base and disposable tray comprising:
a base including a plurality of disposable tip holders and a disposable tray mating portion; and
a disposable tray including;
a work surface including a plurality of mixing wells, an instrument holder and a plurality of disposable tip holders; and
a base mating portion, wherein when said base mating portion of said disposable tray is in cooperation with said tray mating portion of said base, said disposable tray protects said base from being contaminated by materials or instruments held on or in said work surface of said disposable tray.

2. The dental base and disposable tray of claim 1 wherein said disposable tray mating portion includes a locating notch.

3. The dental base and disposable tray of claim 1 wherein said base mating portion includes a locating ridge.

4. The dental base and disposable tray of claim 1 wherein each of said plurality of mixing wells includes one or more material barriers.

5. The dental base and disposable tray of claim 1 wherein said base is configured to provide clearance around said instrument holder to prevent an instrument tip from contacting said base when the instrument is held in said instrument holder.

6. The dental base and disposable tray of claim 1 further comprising a cover for covering one or more of said plurality of mixing wells, wherein said cover prevents contamination and cross-contamination of the materials held in said plurality of mixing wells, further wherein said cover is formed from a light blocking material.

7. The dental base and disposable tray of claim 1 wherein said dental base is stainless steel.

8. The dental base and disposable tray of claim 1 wherein said dental base is metal covered with plastic.

9. The dental base and disposable tray of claim 1 wherein said disposable tray is plastic.

10. The dental base and disposable tray of claim 1 wherein said disposable tray includes a locating ridge and said base includes a corresponding locating notch, wherein the said disposable tray is properly seated to said base when said locating ridge is located within said locating notch.

11. A disposable dental tray comprising:
a work surface including a plurality of mixing wells, an instrument holder, a plurality of disposable tip holders; and
a base mating portion.

12. The disposable dental tray of claim 11 wherein said base mating portion includes a locating ridge.

13. The disposable dental tray of claim 11 wherein each of said plurality of mixing wells includes one or more material barriers.

14. The disposable dental tray of claim 11 further comprising a cover for covering one or more of said plurality of mixing wells, wherein said cover prevents contamination and cross-contamination of the materials held in said plurality of mixing wells, further wherein said cover is formed from a light blocking material.

15. The disposable dental tray of claim 11 wherein said disposable dental tray is plastic.

16. A base for a disposable dental tray comprising:
a plurality of disposable tip holders; and
a disposable tray mating portion.

17. The base of claim 16 wherein said disposable tray mating portion includes a locating notch.

18. The base of claim 16 wherein said base is configured to provide clearance around an instrument holder provided on a corresponding disposable dental tray in order to prevent an instrument tip from contacting said base when the instrument is held in the instrument holder.

19. The base of claim 16 wherein said dental base is stainless steel.

20. The base of claim 16 wherein said dental base is metal covered with plastic.
